(19) United States
(12) Patent Application Publication
(10) Pub. No.: US 2014/0027687 A1
(43) Pub. Date: Jan. 30, 2014

(54) CONSTRUCTION STAPLE REMOVAL TOOL

(71) Applicant: Thomas L. McLaughlin, Olympia, WA (US)

(72) Inventor: Thomas L. McLaughlin, Olympia, WA (US)

(21) Appl. No.: 13/560,393

(22) Filed: Jul. 27, 2012

(51) Int. Cl. B25C 11/00

(52) U.S. Cl. 254/28

(57) ABSTRACT

A rod with termini that are used to remove construction staples, which are utilized in housing construction and electrical assemblies. Each terminus is J-shaped and is configured to pry a closed-end loop of a U-shaped construction staple so as to ease its removal. One terminus has a flatter profile to reach difficult spots where construction staples are located. The other terminus has a hook profile.

### FIELD OF THE INVENTION

The subject matter is generally related to construction tools, and more particularly, is related to a construction staple removal tool.

### BACKGROUND

Staples are fasteners used to affix firmly or securely one construction material to another construction material. Often, they are manufactured with thermal glue attached to the opened ends. When the opened ends are nailed into construction materials, the frictional forces activate the glue and bind these opened ends into the construction materials. Over time, the construction materials are weathered by the elements and those weathered portions should be removed. The problem is that there is a lack of a construction tool that can remove these staples from the weathered portions without damaging other sections of the construction materials that may not yet have to be replaced.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

One aspect of the present subject matter includes a rod form of the subject matter, which recites a rod configured to remove construction staples. The rod comprises a first J-shaped terminus with a first hood having a first convex surface and a first concave surface which form a prong finishing at a first tip. The first tip is angled away from an axis that extends longitudinally along the rod. The rod further comprises a second J-shaped terminus with a second hood having a second convex surface that melds into the first concave surface to form a first surface and a second concave surface that melds into the first convex surface to form a second surface. The second convex surface and the second concave surface form a hook finishing at a second tip.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a pictorial diagram illustrating an archetypical construction staple removal tool being used on a workpiece in accordance with one embodiment of the present subject matter;

FIG. 2 is a pictorial diagram illustrating an archetypical construction staple removal tool being used on a workpiece in accordance with one embodiment of the present subject matter;

FIG. 3 is a pictorial diagram illustrating an archetypical construction staple removal tool being used on a workpiece in accordance with one embodiment of the present subject matter;

FIG. 4 is a pictorial diagram illustrating an archetypical construction staple removal tool being used on a workpiece in accordance with one embodiment of the present subject matter;

FIG. 5 is a side view of an archetypical construction staple removal tool in accordance with one embodiment of the present subject matter;

FIG. 6 is a back view of an archetypical construction staple removal tool in accordance with one embodiment of the present subject matter;

FIG. 7 is a plan view of the top of an archetypical construction staple removal tool in accordance with one embodiment of the present subject matter;

FIG. 8 is a side view of an archetypical construction staple removal tool in accordance with one embodiment of the present subject matter;

FIG. 9 is a front view of an archetypical construction staple removal tool in accordance with one embodiment of the present subject matter;

FIG. 10 is a plan view of a bottom of an archetypical construction staple removal tool in accordance with one embodiment of the present subject matter;

FIG. 11 is a back view of an archetypical construction staple removal tool in accordance with another embodiment of the present subject matter;

FIG. 12 is a front view of an archetypical construction staple removal tool in accordance with another embodiment of the present subject matter;

FIG. 13 is a side view of an archetypical construction staple removal tool in accordance with a further embodiment of the present subject matter;

FIG. 14 is a back view of an archetypical construction staple removal tool in accordance with a further embodiment of the present subject matter;

FIG. 15 is a plan view of a bottom of an archetypical construction staple removal tool in accordance with a further embodiment of the present subject matter;

FIG. 16 is a side view of an archetypical construction staple removal tool in accordance with a further embodiment of the present subject matter;

FIG. 17 is a front view of an archetypical construction staple removal tool in accordance with a further embodiment of the present subject matter; and

FIG. 18 is a plan view of a top of an archetypical construction staple removal tool in accordance with a further embodiment of the present subject matter.

### DETAILED DESCRIPTION

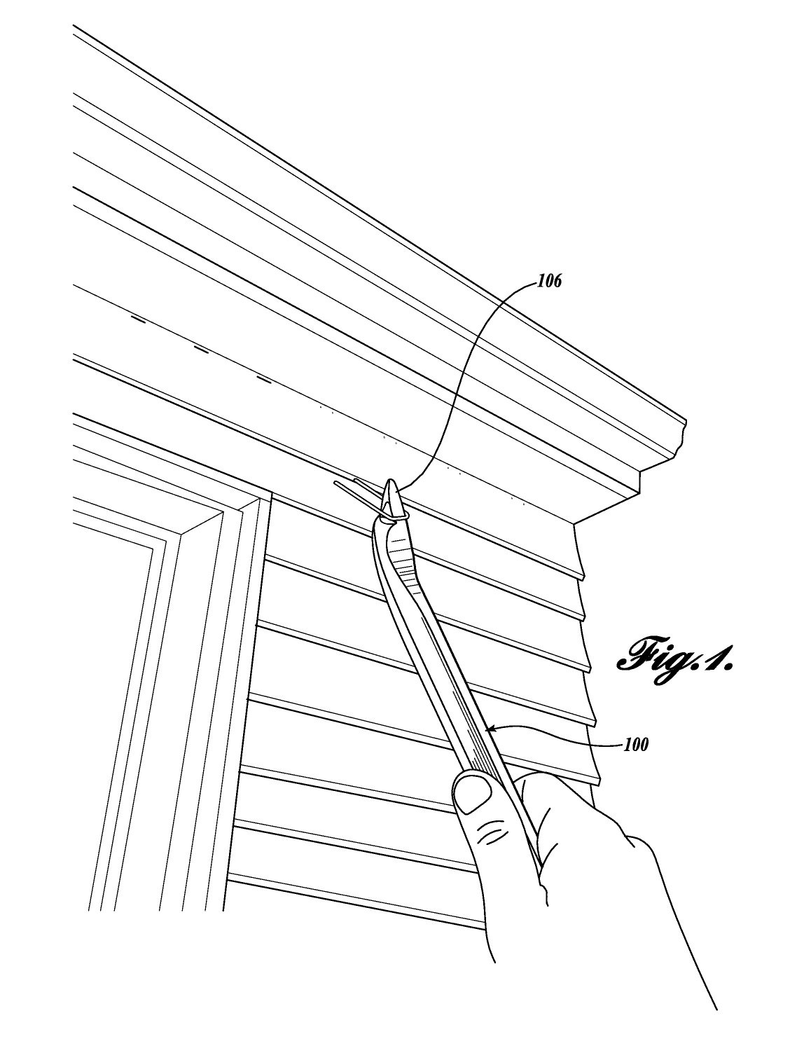

FIG. 1 illustrates an overhang or a projection of a roof beyond the outside walls of a frame building, such as a house. Sidings (as boards) form the exposed surface of these outside walls and define a space into which a window is fitted. FIG. 1 further illustrates construction staples, which are U-shaped metal loops, both termini of which are driven into a surface of a siding to secure it onto the exterior walls. These U-shaped metal loops typically are manufactured with thermal glue near their termini which further acts to fasten the staples into the exterior walls and resist efforts to remove them. FIG. 1 further illustrates the use of a J-shaped terminus 106 of a rod 100 to remove a construction staple workpiece. The rod 100 can be used to remove staples from a section of sidings or roofing or cabinet materials without having to remove sections of sidings or roofing or cabinet materials that need not be replaced.

FIG. 2 illustrates a cross section of a roof and its overhang perpendicularly intersecting with an exterior wall being shown cross-sectionally. Cross sections of sidings are illustrated, all of which are secured to the exterior wall via one or more construction staples. The J-shaped terminus 106 is guided into the closed-end loop of the construction staple in a first position (as indicated by the ghost outline of the rod 100) which is then actuated to a second position to cause a loosening of the staple from the siding by moving the rod 100. The J-shaped terminus 106 is suitably used to pry and remove construction staples that are situated in hard-to-reach locations.

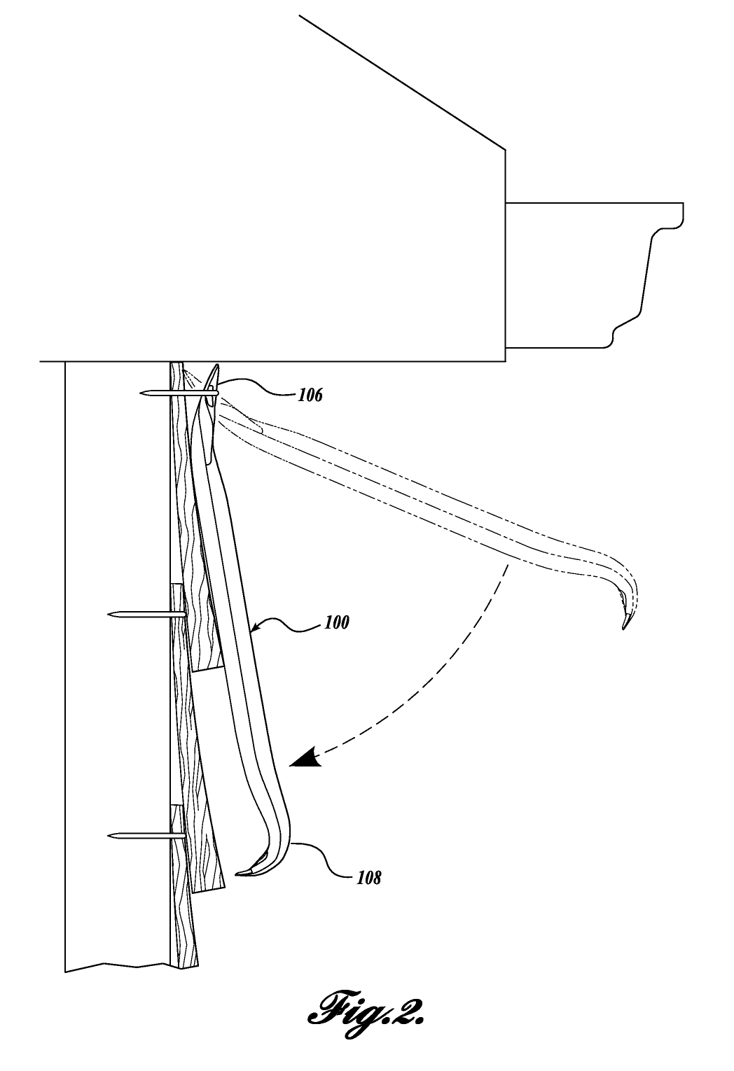

FIG. 3 continues to illustrate cross sections of a roof and its overhang intersecting with an exterior wall. Cross sections of one and more sidings are illustrated. Each siding is secured into the exterior wall via one or more staples as indicated before. The rod 100 includes a J-shaped terminus 108 which hooks into a stapler in a third position (as indicated by the ghost outline) which is then actuated into a fourth position to loosen the staple so as to facilitate its removal. The J-shaped terminus 108 is suitably used to remove construction staples that are situated in easier-to-reach locations.

FIG. 4 illustrates the use of the J-shaped terminus 106 of the rod 100 to remove electrical staples or wire staples. The rod 100 is especially useful to remove electrical staples in those places where electrical wires are stapled to rafters. The termini of the rod 100 may also be utilized to remove staples used in cabinet construction.

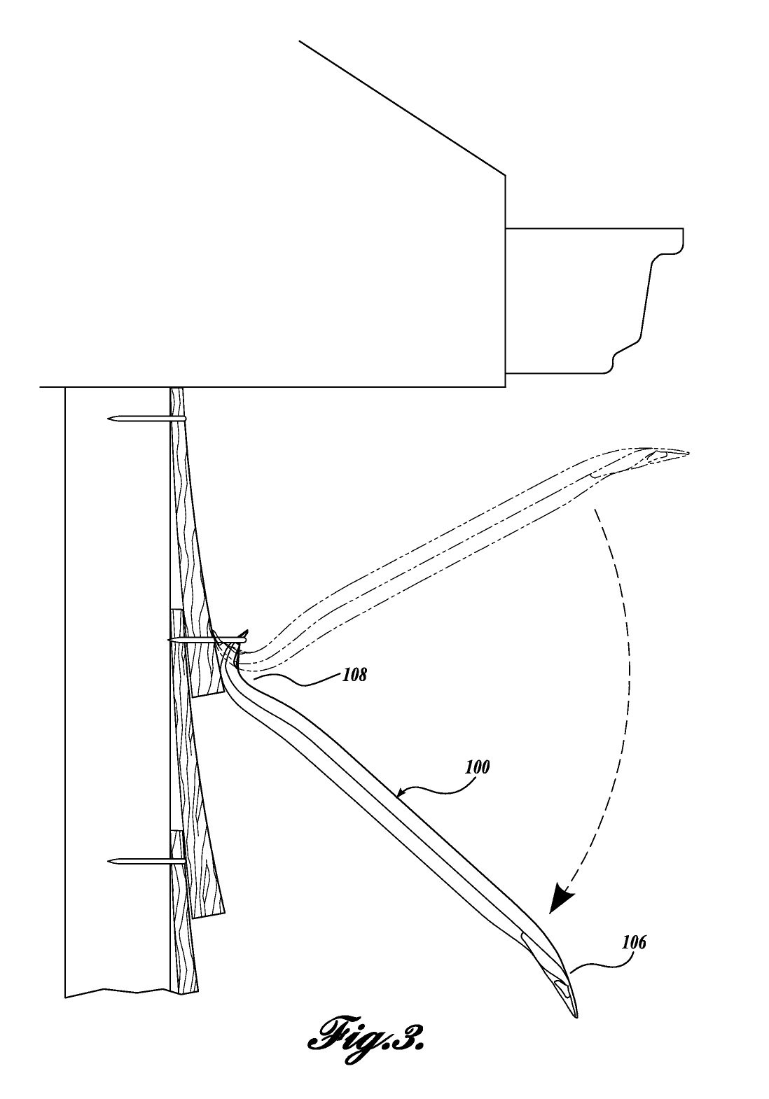

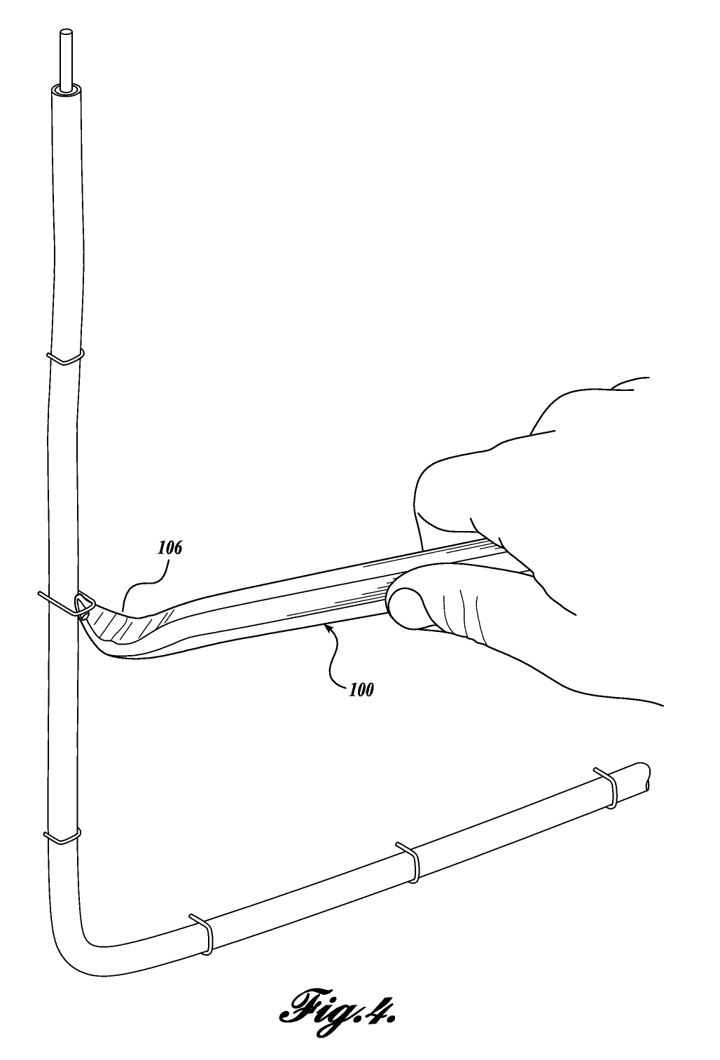

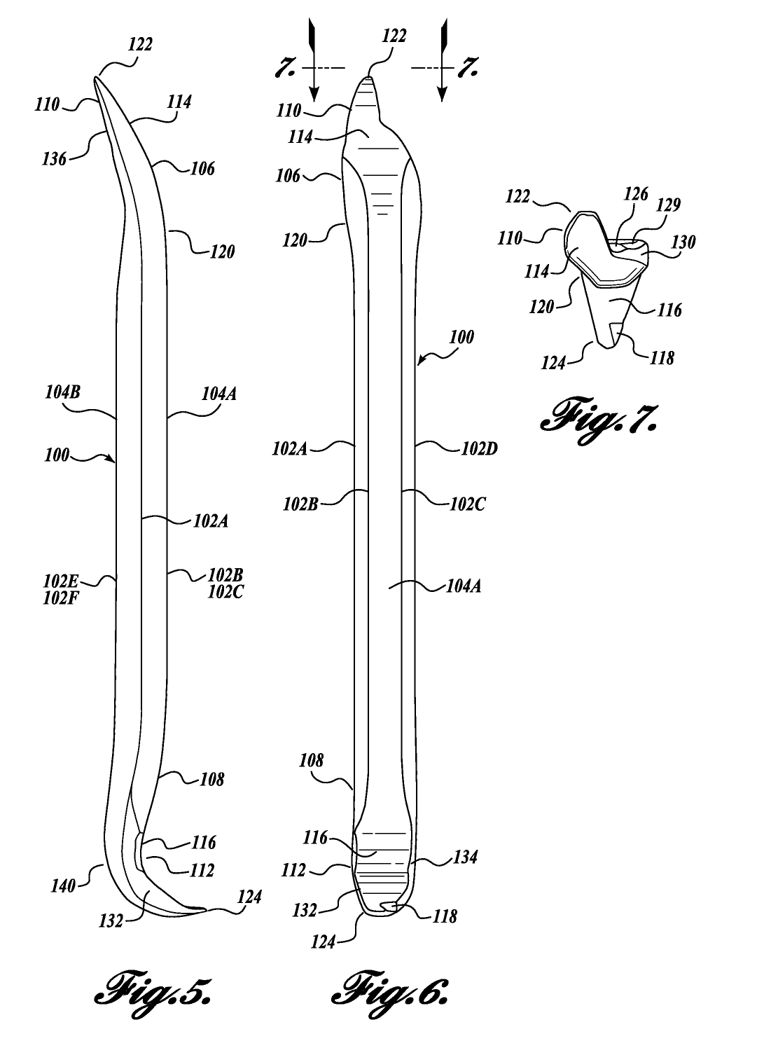

FIGS. 5-10 illustrate the rod 100 in greater detail. The rod 100 can be of any suitable length and suitably made of any suitable material, such as high-grade steel. One suitable length includes 10½ inches measuring from a tip 122 to a tip 124. Another suitable length includes two feet. A further suitable length includes six inches. The rod 100 is about ¾-inch thick but any suitable thicknesses can be used.

The rod 100 includes a body that is sectioned by ridges 102a-102f. Each ridge is a line of intersection of the various sections. One of these sections includes a surface 104a that connects the J-shaped terminus 106 to the J-shaped terminus 108. Each ridge is substantially parallel to another ridge. The ridge 102b is substantially parallel to the ridge 102c which together delimits the surface 104a. When the ridges 102b, 102c reach the J-shaped terminus 106, they diverge and extend in different directions upon encountering a hood 120 which structurally expands to give strength to a prong 110 of the J-shaped terminus 106.

The surface 104a encounters a convex surface 114 of the hood 120 to finish at the tip 122 of the J-shaped terminus 106. In one embodiment, measuring from the hood 120 to the tip 122, a suitable length includes 2 inches. Other suitable lengths may be used without limiting the present subject matter. In one embodiment, suppose an axis exists that is coaxially located in relation to the ridge 102a and continues longitudinally to extend beyond the tip 122. In this embodiment, the tip 122 angles away from the mentioned axis by an approximate 18 to 20 degrees. In another embodiment, suppose an axis exists that perpendicularly locates in relation to the ridge 102a. In this embodiment, the tip 122 is measured at an angle that is approximately 100 degrees from the mentioned axis.

The ridges 102e-102f delimit a surface 104b that connects a concave surface 136 of the J-shaped terminus 106 with a convex surface 138 of the J-shaped terminus 108. The convex surface 138 is also used as an end to receive blows from a hammer to allow the tip 122 to enter into the closed-end loop of a staple. The concave surface 136 melds into the prong 110 to finish at the tip 122. At the base of the tip 122 is a polyhedron-defined void 126 that includes at least two sides that etch into the prong 110. Leading to the polyhedron-defined void 126 is a gradient surface 130 having greater surface area than a gradient surface 129 that abuts the polyhedron-defined void 126.

The J-shaped terminus 108 of the rod 100 finishes in a hook 112. The hook 112 is used to break the thermal bond between the opened ends of a staple and the construction material (e.g., sidings or walls). The tip 124, in one embodiment, measures at an angle of approximately 30 degrees from an axis that runs lengthwise along the ridge 102a, and approximately 60 degrees from an axis that runs perpendicular to the ridge 102a. The gradient surface 132 veers from the axis that is in parallel to the ridge 102a by about 10 to 12 degrees to finish at the hook 112. The gradient surface 134, similarly, veers from the axis that is in parallel to the ridge 102d by about 10 to 12 degrees to converge with the gradient surface 132 to finish at the hook 112.

As mentioned previously, the surface 104a melds into the concave surface 116 which defines a hood 140 which is a structural expansion of the J-shaped terminus 108 to lend structural strength to the hook 112. The concave surface 116 is adjacent to gradient surfaces 132, 134. The concave surface 116, gradient surface 132, and gradient surface 134 end at the tip 124. A polyhedron-shaped indentation 118 mars the base of the tip 124 providing definition to allow the hook 112 to easily gain entry into the closed-end loop of the staple. In one embodiment, a suitable length of the hook 112 is approximately 1½ inches. Other suitable lengths of the hook 112 may be used without limiting the present subject matter.

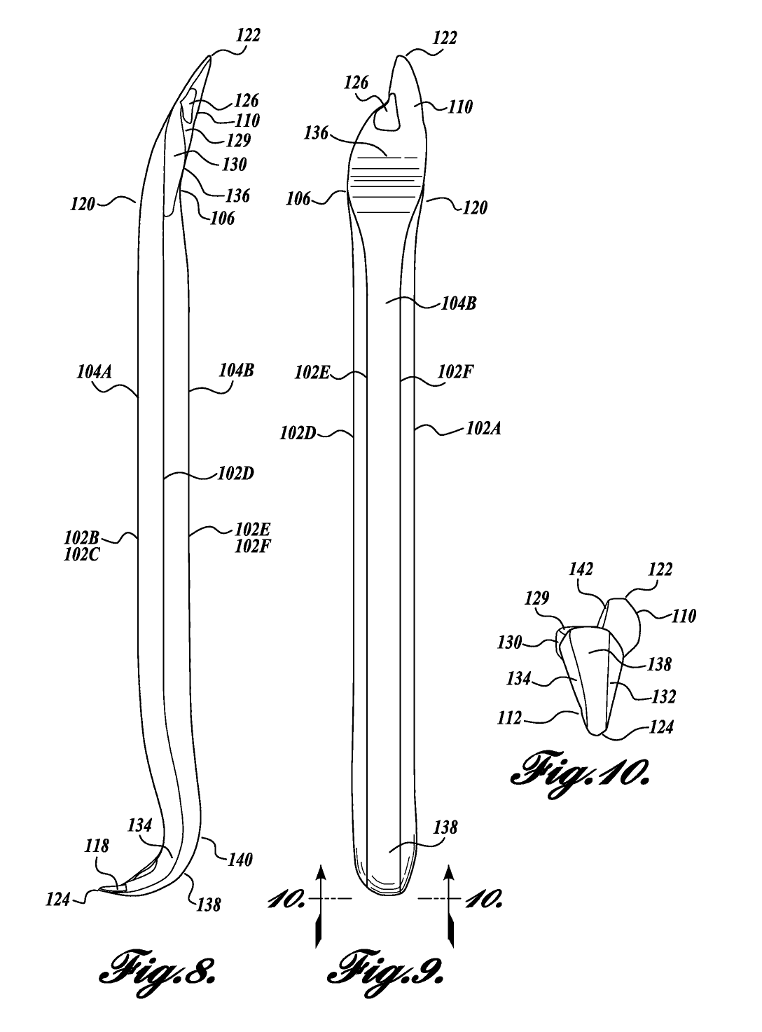

FIGS. 11, 12 illustrate another embodiment of the J-shaped terminus 106. FIGS. 11, 12 illustrate elements that are similar to elements illustrated in FIGS. 5-10, and for brevity purposes, some of them will not be repeated here. A rod 1100 includes a J-shaped terminus 1106 that is similar in many ways to the J-shaped terminus 106 except that the prong 1110 is substantially aligned with the axis of the rod 1100 (that is, in parallel and running longitudinally along the surfaces 1104a, 1104b) instead of the tilting or slanting of the prong 110 of the J-shaped terminus 106 from the axis (that is, in parallel and running longitudinally along the surfaces 104a, 104b) of the rod 100. In one embodiment, the tilting or slanting of the prong 110 is measured from the tip 122 about 18 to 20 degrees from the mentioned axis.

The rod 1100 can be of any suitable length. One suitable length includes 10½ inches measuring from a tip 1122 to a tip 1124. The rod 1100 includes a body that is sectioned by ridges 1102a-1102f. Each ridge is a line of intersection of the various sections. One of these sections includes a surface 1104a that connects the J-shaped terminus 1106 to the J-shaped terminus 1108. Each ridge is substantially parallel to another ridge. The ridge 1102b is substantially parallel to the ridge 1102c which together delimits the surface 1104a. When the ridges 1102b, 1102c reach the J-shaped terminus 1106, they diverge and extend in different directions upon encountering a hood 1120 which structurally expands to give strength to a prong 1110 of the J-shaped terminus 1106.

The surface 1104a encounters a convex surface 1114 of the hood 1120 to finish at the tip 1122 of the J-shaped terminus 1106. In one embodiment, measuring from the hood 1120 to the tip 1122, a suitable length includes two inches. Other suitable lengths may be used without limiting the present subject matter. In one embodiment, suppose an axis exists that is coaxially located in relation to the ridge 1102a and continues longitudinally to extend beyond the tip 1122. In this embodiment, the tip 1122 angles away from the mentioned axis by an approximate 18 to 20 degrees. In another embodiment, suppose an axis exists that is located perpendicularly in relation to the ridge 1102a. In this embodiment, the tip 1122 is measured at an angle that is approximately 100 degrees from the mentioned axis.

The ridges 1102e-1102f delimit a surface 1104b that connects a concave surface 1136 of the J-shaped terminus 1106 with the convex surface 1138 of the J-shaped terminus 108. The concave surface 1136 melds into the prong 1110 to finish at the tip 1122. At the base of the tip 1122 is a polyhedron-defined void 1126 that includes at least two sides that etch into the prong 1110. Leading to the polyhedron-defined void 1126 is a gradient surface 1130 having greater surface area than a gradient surface 1129 that abuts the polyhedron-defined void 1126.

The J-shaped terminus 1108 of the rod 1100 finishes in a hook 1112. As mentioned previously, the surface 1104a melds into the concave surface 1116 which defines a hood which is a structural expansion of the J-shaped terminus 1108 to lend strength, structural strength, to the hook 1112. The concave surface 1116 is adjacent to gradient surfaces 1132, 1134. Both the concave surface 1116, gradient surface 1132, and gradient surface 1134 end at the tip 1124. A polyhedron-shaped indentation 1118 mars the base of the tip 1124 providing definition to allow the hook 1112 to more easily gain entry into the end portion of a staple. In one embodiment, a suitable length of the hook 1112 is approximately 1½ inches. Other suitable lengths of the hook 1112 may be used without limiting the present subject matter.

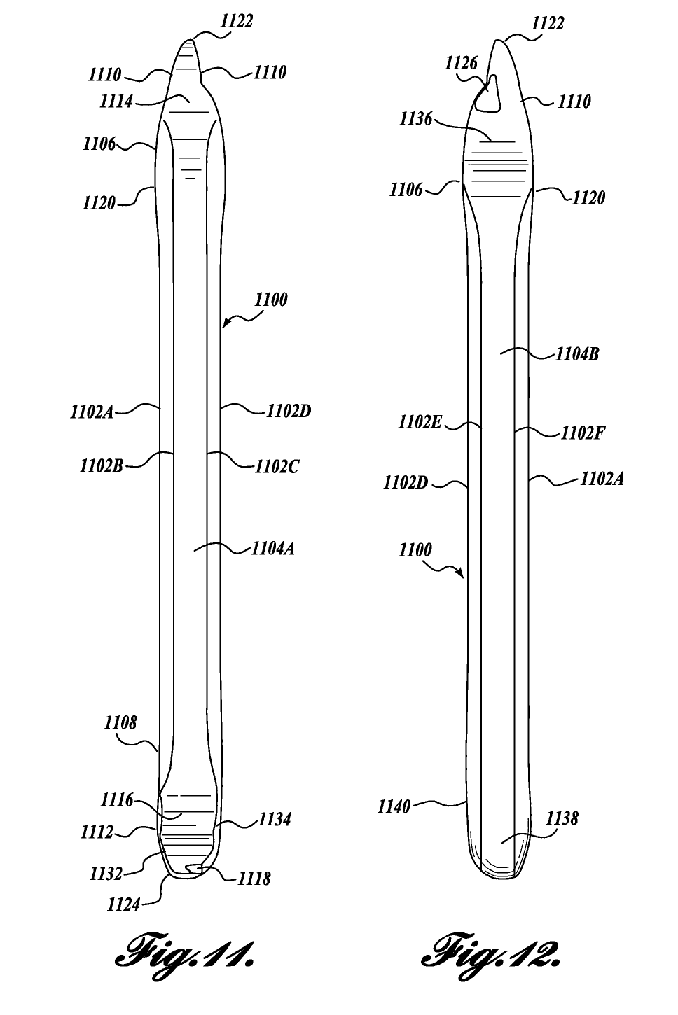

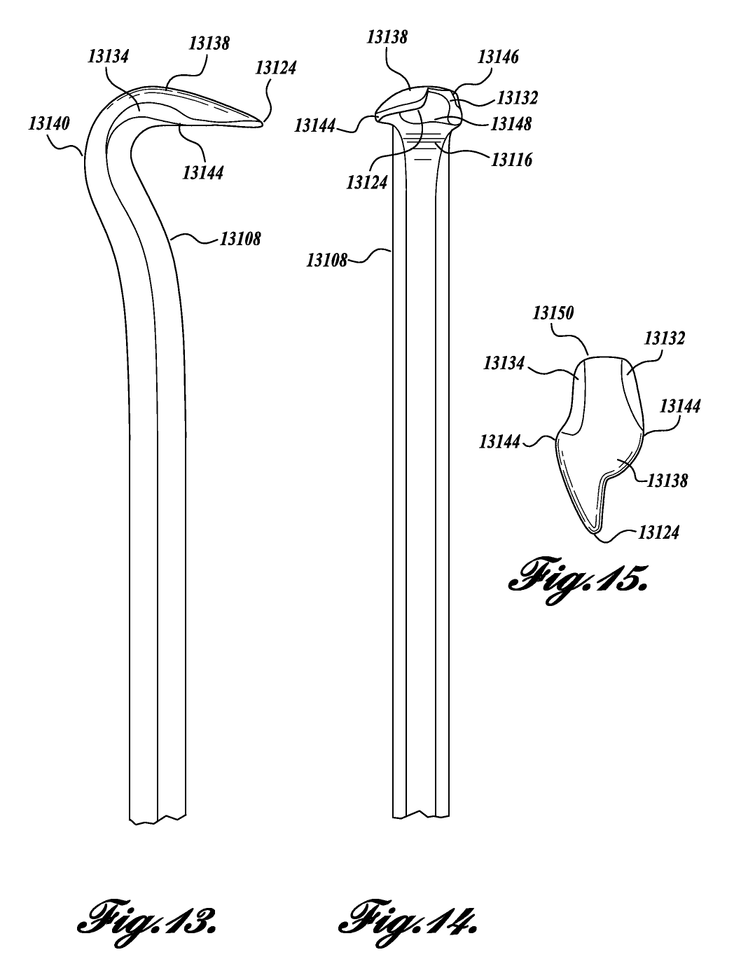

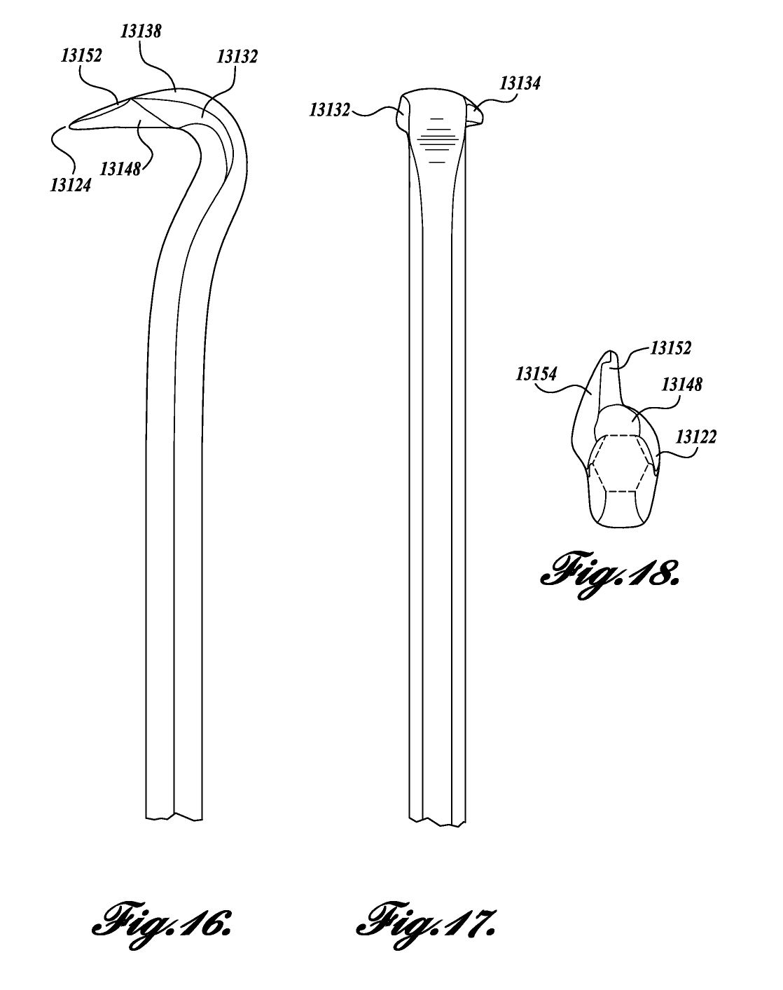

FIGS. 13-18 illustrate another embodiment of the J-shaped terminus 108 renumbered now as J-shaped terminus 13108. Many elements of the J-shaped terminus 13108 are similar to elements of the J-shaped terminus 108, and for brevity purposes, some of them will not be repeated here. The J-shaped terminus 13108 includes a hood 13140 that lends structural strength by expanding the base of a hook 13112. The hook 13112 ends in a tip 13124, which is substantially perpendicular to an axis that runs lengthwise along the rod. Convex surface 13138 and concave surface 13116 shape the hook 13112, starting with a gradient surface 13134 which borders on the convex surface 13138, and then encounters a flare 13144 that lends structural strength to the hook 13112. A gradient surface 13146 intersects with a gradient surface 13132 that ultimately intersects with an oblong-defined void 13148 that borders on the concave surface 13116. A neck 13150 substantially defines a separation between the hood 13140 and the convex surface 13138. The tip 13124 is formed from a gradient surface 13152 which intersects with another gradient surface 13154.

While illustrative embodiments have been illustrated and described, it will be appreciated that various changes can be made therein without departing from the spirit and scope of the invention.

The embodiments of the invention in which an exclusive property or privilege is claimed are defined as follows:

1. A rod configured to remove construction staples, comprising:
a first J-shaped terminus with a first hood having a first convex surface and a first concave surface which form a prong finishing at a first tip, the first tip being angled away from an axis that extends longitudinally along the rod; and
a second J-shaped terminus with a second hood having a second convex surface that melds into the first concave surface to form a first surface and a second concave surface that melds into the first convex surface to form a second surface, the second convex surface and the second concave surface forming a hook finishing at a second tip.

2. The rod of claim 1, wherein a length of the first J-shaped terminus measuring from the first hood to the first tip is approximately 2 inches.

3. The rod of claim 1, wherein the first tip angles between 18 to 20 degrees away from the axis that extends longitudinally along the rod.

4. The rod of claim 1, wherein the prong includes a polyhedron-defined void that includes at least two sides at the base of the first tip.

5. The rod of claim 1, wherein leading to the polyhedron-defined void is a gradient surface having greater surface area than a gradient surface that abuts the polyhedron-defined void.

6. The rod of claim 1, wherein the prong slants from an axis that is in parallel and runs longitudinally along the first and the second surface.

7. The rod of claim 1, wherein the prong is substantially aligned with an axis that is in parallel and runs longitudinally along the first and the second surface.

8. The rod of claim 1, wherein the second concave surface of the hook is adjacent to first and second gradient surfaces, both of which end at the second tip.

9. The rod of claim 1, wherein a polyhedron-shaped indentation mars the base of the second tip to provide definition to the hook.

10. The rod of claim 1, wherein the hook is measured to be about 1½ inches.

11. The rod of claim 1, wherein the hook is substantially perpendicular to an axis that runs lengthwise along the rod.

12. The rod of claim 11, further comprising a flare that encounters a first gradient surface bordering on the second convex surface and a second gradient surface that borders on the second concave surface.

13. The rod of claim 12, further comprising an oblong-defined void that intersects with the second gradient surface and borders on the second concave surface.

14. The rod of claim 13, wherein the hook has a length of approximately 2 inches.
